(19) United States
(12) Patent Application Publication
(10) Pub. No.: US 2015/0319767 A1
(43) Pub. Date: Nov. 5, 2015

(54) BURSTY-INTERFERENCE-AWARE INTERFERENCE MANAGEMENT UTILIZING RUN-LENGTHS

(71) Applicant: QUALCOMM Incorporated, San Diego, CA (US)

(72) Inventors: Kambiz AZARIAN YAZDI, San Diego, CA (US); Nachiappan VALLIAPPAN, San Diego, CA (US)

(73) Assignee: QUALCOMM Incorporated, San Diego, CA (US)

(21) Appl. No.: 14/268,438

(22) Filed: May 2, 2014

(51) Int. Cl. H04W 72/08; H04W 28/02; H04B 17/318; H04B 1/10

(52) U.S. Cl. CPC H04W 72/082; H04B 1/1027; H04W 28/0242; H04B 17/318

(57) ABSTRACT

Interference management for a wireless device in a wireless communication system may operate by, for example, determining a loss pattern from one or more block acknowledgement (ACK) bitmaps. The loss pattern may comprise a plurality of values indicating reception success or reception failure of a corresponding media access control (MAC) protocol data unit (MPDU) at a receiving station. A run-length (RL) vector may be computed characterizing, in length and frequency of occurrence, runs of consecutive reception failures and/or reception successes in the loss pattern. The RL vector may be compared to a corresponding RL signature for distinguishing bursty from non-bursty interference. Based on the comparison, a bursty interference condition may be identified, and a bursty interference indicator may be generated based on the identification of the bursty interference condition.

### REFERENCE TO CO-PENDING APPLICATIONS FOR PATENT

The present application for patent is related to the following co-pending U.S. patent application:

“BURSTY-INTERFERENCE-AWARE INTERFERENCE MANAGEMENT UTILIZING CONDITIONAL METRIC,” having Attorney Docket No. QC134688U1, filed concurrently herewith, assigned to the assignee hereof, and expressly incorporated herein by reference in its entirety.

### INTRODUCTION

Aspects of this disclosure relate generally to telecommunications, and more particularly to interference management and the like.

Wireless communication systems are widely deployed to provide various types of communication content, such as voice, data, and so on. Typical wireless communication systems are multiple-access systems capable of supporting communication with multiple users by sharing available system resources (e.g., bandwidth, transmit power, etc.). One class of such multiple-access systems is generally referred to as “Wi-Fi,” and includes different members of the Institute of Electrical and Electronics Engineers (IEEE) 802.11 wireless protocol family. Generally, a Wi-Fi communication system can simultaneously support communication for multiple wireless stations (STAs). Each STA communicates with one or more access points (APs) via transmissions on the downlink and the uplink. The downlink (DL) refers to the communication link from the APs to the STAs, and the uplink (UL) refers to the communication link from the STAs to the APs.

Various protocols and procedures in Wi-Fi, such as carrier sense multiple access (CSMA), allow different STAs operating on the same channel to share the same wireless medium. However, because of hidden terminals, for example, Wi-Fi STAs operating in neighboring basic service sets (BSSs) on the same channel may still interfere with one another. This interference degrades the performance of the wireless link because of increased packet losses. Packet losses in dense Wi-Fi deployments may be broadly classified into three types: packet losses due to channel fading; packet collisions due to long, data packet transmissions (usually DL transmissions from other co-channel APs and/or STAs); and packet collisions due to short, bursty (time-selective) packet transmissions (usually acknowledgement, management, and upper layer packets from other co-channel APs and/or STAs). Conventional rate control algorithms are not designed to handle bursty interference.

There accordingly remains a need for classifying the type of packet errors/interference observed according to the nature of the interferer and channel conditions, and for taking remedial actions appropriate to the type of packet errors/interference determined to be present.

### SUMMARY

Systems and methods for interference management for a wireless device in a wireless communication system are disclosed.

A method of interference management for a wireless device in a wireless communication system is disclosed. The method may comprise, for example: determining a loss pattern from one or more block acknowledgement (ACK) bitmaps, the loss pattern comprising a plurality of values indicating reception success or reception failure of a corresponding media access control (MAC) protocol data unit (MPDU) at a receiving station; computing a run-length (RL) vector characterizing, in length and frequency of occurrence, runs of consecutive reception failures and/or reception successes in the loss pattern; comparing the RL vector to a corresponding RL signature for distinguishing bursty from non-bursty interference; identifying a bursty interference condition based on the comparison; and generating a bursty interference indicator based on the identification of the bursty interference condition.

An apparatus for interference management for a wireless device in a wireless communication system is also disclosed. The apparatus may comprise, for example, a processor and memory coupled to the processor for storing related data and instructions. The processor may be configured to, for example: determine a loss pattern from one or more block ACK bitmaps, the loss pattern comprising a plurality of values indicating reception success or reception failure of a corresponding MPDU at a receiving station; compute a RL vector characterizing, in length and frequency of occurrence, runs of consecutive reception failures and/or reception successes in the loss pattern; compare the RL vector to a corresponding RL signature for distinguishing bursty from non-bursty interference; identify a bursty interference condition based on the comparison; and generate a bursty interference indicator based on the identification of the bursty interference condition.

Another apparatus for interference management for a wireless device in a wireless communication system is also disclosed. The apparatus may comprise, for example: means for determining a loss pattern from one or more block ACK bitmaps, the loss pattern comprising a plurality of values indicating reception success or reception failure of a corresponding MPDU at a receiving station; means for computing a RL vector characterizing, in length and frequency of occurrence, runs of consecutive reception failures and/or reception successes in the loss pattern; means for comparing the RL vector to a corresponding RL signature for distinguishing bursty from non-bursty interference; means for identifying a bursty interference condition based on the comparison; and means for generating a bursty interference indicator based on the identification of the bursty interference condition.

A computer-readable medium comprising code, which, when executed by a processor, causes the processor to perform operations for interference management for a wireless device in a wireless communication system is also disclosed. The computer-readable medium may comprise, for example: code for determining a loss pattern from one or more block ACK bitmaps, the loss pattern comprising a plurality of values indicating reception success or reception failure of a corresponding MPDU at a receiving station; code for computing a RL vector characterizing, in length and frequency of occurrence, runs of consecutive reception failures and/or reception successes in the loss pattern; code for comparing the RL vector to a corresponding RL signature for distinguishing bursty from non-bursty interference; code for identifying a bursty interference condition based on the comparison; and code for generating a bursty interference indicator based on the identification of the bursty interference condition.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless network.

FIG. 2 illustrates example classes of interference that may be experienced by nodes in a wireless network.

FIG. 3 illustrates the effect of bursty interference during an example transmission opportunity.

FIG. 4 is a block diagram illustrating an example bursty-interference-aware interference management module for a wireless device in a wireless communication system.

FIG. 5 is a block diagram illustrating an example design for one or more bursty interference detection aspects of a bursty-interference-aware interference management module.

FIG. 6 is an example data flow diagram illustrating the population of an example run-length (RL) vector.

FIG. 7 is an illustrative example of a RL distribution that may be employed as a RL signature.

FIG. 8 is an illustrative example of a RL distribution that may be derived from the RL vector in bursty interference conditions.

FIG. 9 is a signaling flow diagram illustrating the empirical generation of a baseline RL distribution that is characteristic of non-bursty interference.

FIG. 10 is an illustrative example of a RL threshold that may be employed as a RL signature.

FIG. 11 is a processing flow diagram illustrating the empirical adaptation of a RL threshold for separating bursty and non-bursty interference.

FIG. 12 is another processing flow diagram illustrating the empirical adaptation of a RL threshold for separating bursty and non-bursty interference.

FIG. 13 is a block diagram illustrating an example design for one or more bursty interference control aspects of a bursty-interference-aware interference management module.

FIG. 14 is a block diagram illustrating another example design for one or more bursty interference control aspects of a bursty-interference-aware interference management module.

FIG. 15 is a flow diagram illustrating an example method of interference management for a wireless device in a wireless communication system.

FIG. 16 is a simplified block diagram of several sample aspects of components that may be employed in communication nodes.

FIG. 17 is a simplified block diagram of several sample aspects of communication components.

FIG. 18 is a simplified block diagram of several sample aspects of apparatuses configured to support communication as taught herein.

### DETAILED DESCRIPTION

The disclosure relates in some aspects to interference management for a wireless device in a wireless communication system. By comparing a run-length (RL) vector characterizing runs of consecutive reception failures and/or reception successes to a corresponding RL signature, a bursty interference condition may be identified on a communication channel. The RL vector may be derived from block acknowledgement (block ACK) information, which may be pre-processed to remove any redundant bits. The RL signature may comprise, for example, a baseline RL distribution or a RL threshold of consecutive reception failures that is characteristic of non-bursty interference (e.g., channel fading or long data packet collisions), as a basis to determine when observed RL values have deviated from those expected in non-bursty conditions. By providing bursty-interference-aware interference management, the present disclosure enables more sophisticated rate control to increase user throughputs and enhance overall network capacity.

Aspects of the disclosure are provided in the following description and related drawings directed to specific disclosed aspects. Alternate aspects may be devised without departing from the scope of the disclosure. Additionally, well-known aspects of the disclosure may not be described in detail or may be omitted so as not to obscure more relevant details. Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

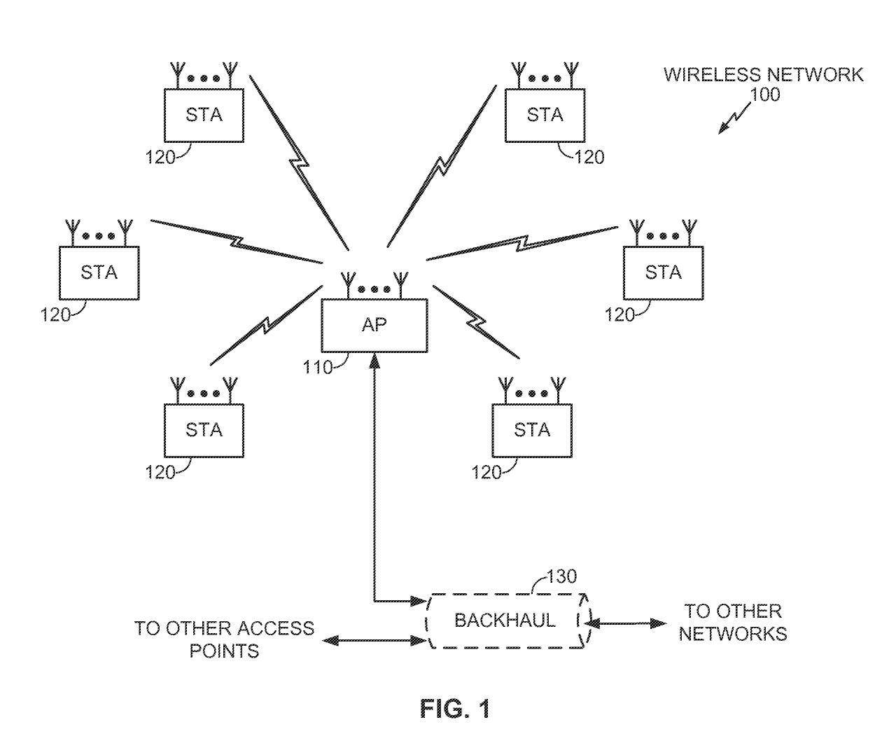

FIG. 1 illustrates an example wireless network 100. As shown, the wireless network 100, which may also be referred to herein as a basic service set (BSS), is formed from several wireless nodes, including an access point (AP) 110 and a plurality of subscriber stations (STAs) 120. Each wireless node is generally capable of receiving and/or transmitting. The wireless network 100 may support any number of APs 110 distributed throughout a geographic region to provide coverage for the STAs 120. For simplicity, one AP 110 is shown in FIG. 1, providing coordination and control among the STAs 120, as well as access to other APs or other networks (e.g., the Internet) via a backhaul connection 130.

The AP 110 is generally a fixed entity that provides backhaul services to the STAs 120 in its geographic region of coverage. However, the AP 110 may be mobile in some applications (e.g., a mobile device serving as a wireless hotspot for other devices). The STAs 120 may be fixed or mobile. Examples of STAs 120 include a telephone (e.g., cellular telephone), a laptop computer, a desktop computer, a personal digital assistant (PDA), a digital audio player (e.g., MP3 player), a camera, a game console, a display device, or any other suitable wireless node. The wireless network 100 may be referred to as a wireless local area network (WLAN), and may employ a variety of widely used networking protocols to interconnect nearby devices. In general, these networking protocols may be referred to as “Wi-Fi,” including any member of the Institute of Electrical and Electronics Engineers (IEEE) 802.11 wireless protocol family.

For various reasons, interference may exist in the wireless network 100, leading to different degrees of packet loss and degradations of performance. The interference may be derived from different sources, however, and different classes of interference may affect the wireless network 100 in different ways. Several example classes of interference are described below.

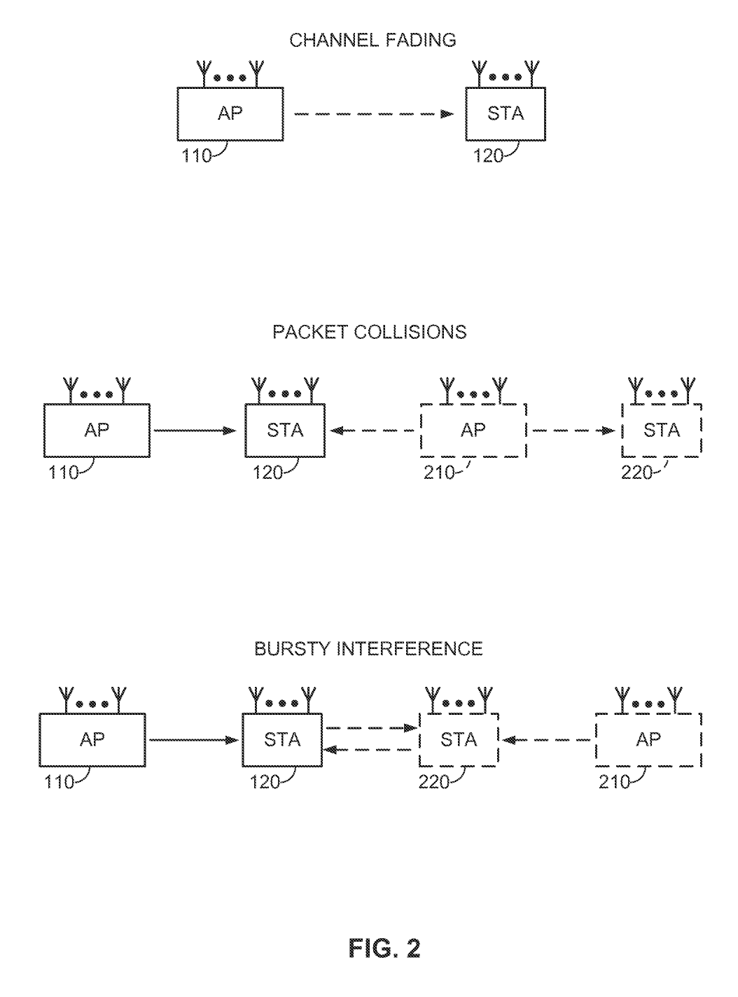

FIG. 2 illustrates several example classes of interference that may be experienced by nodes in a wireless network. In each of the examples, the AP 110 and one of the STAs 120 of the wireless network 100 from FIG. 1 are engaged in a downlink communication session where the AP 110 sends one or more packets to the STA 120.

In the first illustrated interference scenario, the communication link between the AP 110 and the STA 120 experiences time-varying signal conditions due to environmental variations, such as multipath propagation effects or shadowing. This interference scenario is typically referred to as channel fading.

In the second illustrated interference scenario, the STA 120 is operating in the vicinity of another BSS including a neighboring AP 210 and a neighboring STA 220. Because the STA 120 is within range of the neighboring AP 210, co-channel transmissions from the neighboring AP 210 to the neighboring STA 220 will be received at the STA 120 as well, thereby distorting channel conditions and interfering with the communication link between the AP 110 and the STA 120. This interference scenario is typically referred to as (long) packet collisions.

In the third illustrated interference scenario, the STA 120 is again operating in the vicinity of another BSS including the neighboring AP 210 and the neighboring STA 220. Here, the STA 120 is out of range of the neighboring AP 210 but within range of the neighboring STA 220. Because the STA 120 is within range of the neighboring STA 220, any transmissions from the neighboring STA 220 to the neighboring AP 210 may potentially interfere with the communication link between the AP 110 and the STA 120. (The same is true of transmissions from the STA 120 to the AP 110, which may potentially interfere with the communication link between the neighboring AP 210 and the neighboring STA 220, as shown.) Examples of potentially interfering communications include not only uplink data traffic, but also acknowledgement (ACK) messages, management messages, and various other upper layer signaling. This interference scenario is typically referred to as (short) bursty interference, and derives from the “hidden node” or “hidden terminal” problem.

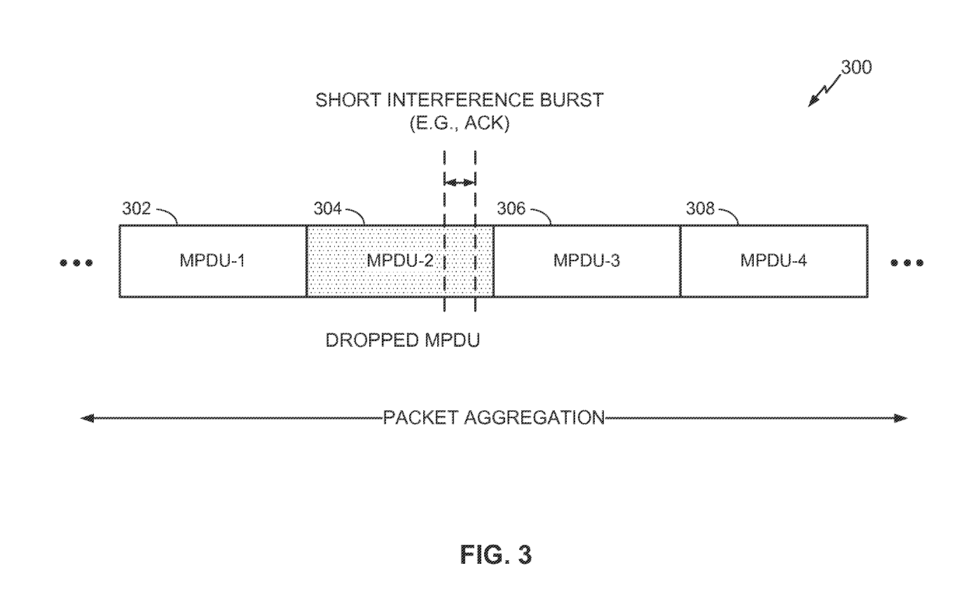

FIG. 3 illustrates the effect of bursty interference during an example transmission opportunity (TxOP). In this example, the transmission 300 includes an aggregation of media access control (MAC) protocol data units (MPDUs), including a first MPDU (MPDU-1) 302, a second MPDU (MPDU-2) 304, a third MPDU (MPDU-3) 306, and a fourth MPDU (MPDU-4) 308. An MPDU is a message subframe exchanged between MAC entities, such as the AP 110 and one of the STAs 120 of the wireless network 100 shown in FIG. 1. When the MPDU is larger than the MAC service data unit (MSDU) received from a higher layer in the protocol stack, the MPDU may include multiple MSDUs as a result of packet aggregation. When the MPDU is smaller than the MSDU, each MSDU may generate multiple MPDUs as a result of packet segmentation.

As shown, the second MPDU (MPDU-2) 304 is subjected to a short burst of interference, such as an ACK message from a neighboring node as discussed above in relation to FIG. 2. The interference bursts causes the decoding of the second MPDU (MPDU-2) 304 to fail, and for the second MPDU (MPDU-2) 304 to be dropped.

As discussed in the background above, conventional rate control algorithms are designed to handle channel fading and packet collision interference scenarios, not bursty interference scenarios such as the one illustrated in FIG. 3. In fact, conventional rate control algorithms applied to bursty interference may actually exacerbate the effect of the interference. For example, reducing the transmission rate in response to the dropped MPDU (e.g., via a lower modulation and coding scheme), as appropriate for a packet collision interference scenario, decreases the number of MPDUs transmitted during a given TxOP and therefore increases the relative impact of a short interference burst. By providing bursty-interference-aware interference management, the present disclosure enables more sophisticated rate control to increase user throughputs and enhance overall network capacity.

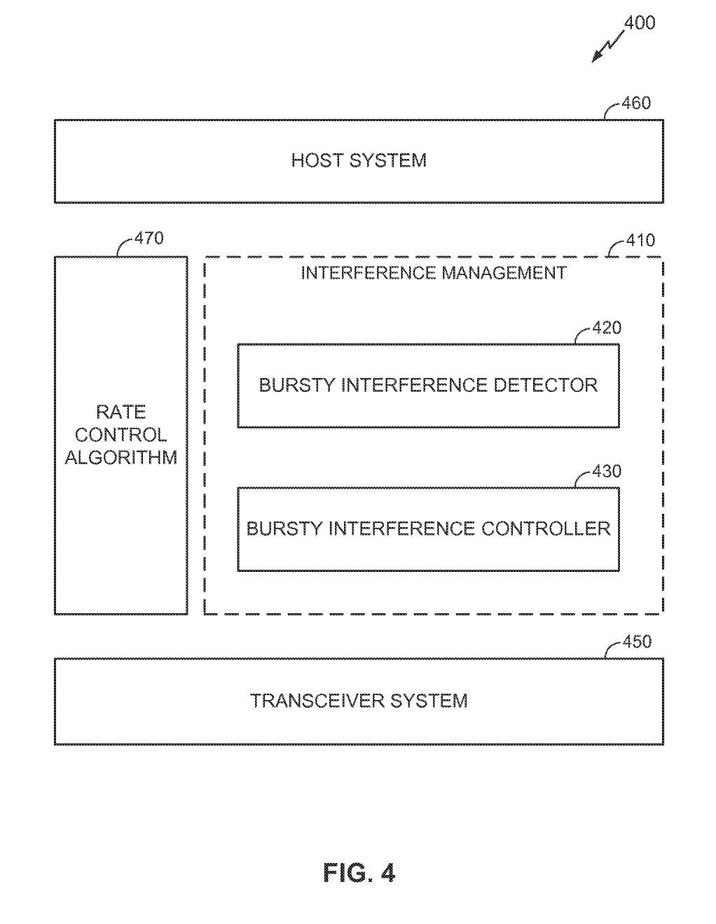

FIG. 4 is a block diagram illustrating an example bursty-interference-aware interference management module for a wireless device in a wireless communication system. The wireless device 400 in which the interference management module 410 is deployed may be a Wi-Fi access point, for example, such as the AP 110 in FIG. 1, but more generally any entity performing or assisting with rate control (e.g., one of the STAs 120 in FIG. 1). In other examples, the illustrated components may be spread out over multiple entities (e.g., one of the STAs 120 in FIG. 1 may perform some of the processing operations itself before sending the results thereof to the AP 110 for rate control purposes).

As shown, the interference management module 410 may be deployed in conjunction with native transceiver system functionality 450 and host system functionality 460 of the wireless device 400. The transceiver system 450 provides the requisite wireless communication functionality in accordance with a given communication protocol (e.g., Wi-Fi), and may include one or more antennas, modulators, demodulators, buffers, TX/RX processors, and so on. Among other tasks, the transceiver system 450 in this example configuration performs packet (e.g., MPDU) processing and associated functions. The host system 460 provides the application-oriented services for the wireless device 400, and may include a processor, associated memory, software for a variety of applications, special purpose modules, and so on.

The interference management module 410 may also be deployed in conjunction with a rate control algorithm 470 operating at the wireless device 400. Rate control algorithms are employed by wireless devices to control the transmission data rate by optimizing system performance. They may operate, for example, based on throughput calculations and drop probabilities associated with different rates (e.g., a table that is dynamically populated or derived from predetermined simulations). If the current throughput is less than the drop probability, for example, the rate control algorithm may increase the transmission data rate.

Turning to the interference management module 410 in more detail, the interference management module 410 may include a bursty interference detector 420 and a bursty interference controller 430. The bursty interference detector 420 is configured to identify a bursty interference condition on a communication channel, as distinguished from channel fading interference and packet collisions. In response to the identification, the bursty interference controller 430 is configured to take remedial action to address the bursty interference condition. The bursty interference detector 420 and the bursty interference controller 430 may be implemented in different ways according to different designs and applications. Several examples are provided below.

It will be appreciated that although the disclosed examples may be discussed individually for illustration purposes, different aspects of the different implementations for the bursty interference detector 420 and/or the bursty interference controller 430 may be combined in different ways, not only with other disclosed aspects but also with other aspects beyond the scope of this disclosure, as appropriate. Conversely, it will be appreciated that different aspects of the different implementations for the bursty interference detector 420 and/or the bursty interference controller 430 may be used independently, even if described in concert for illustration purposes.

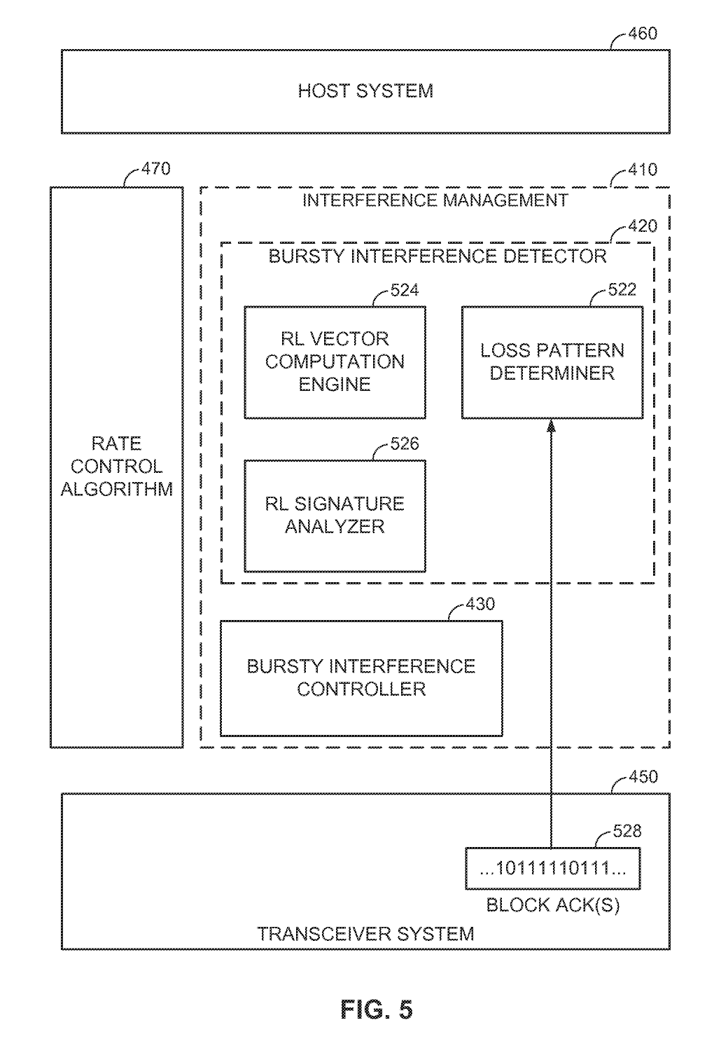

FIG. 5 is a block diagram illustrating an example design for one or more bursty interference detection aspects of a bursty-interference-aware interference management module. In this example, the bursty interference detector 420 includes a loss pattern determiner 522, a run-length (RL) vector computation engine 524, and a RL signature analyzer 526.

The loss pattern determiner 522 is configured to determine a loss pattern from one or more block ACK bitmaps 528. In Wi-Fi, for example, instead of transmitting an individual ACK message for every MPDU, multiple MPDUs can be acknowledged together using a single “block ACK” frame. Each bit of the block ACK bitmap represents the status (success/failure) of a corresponding MPDU. In the illustrated example, the loss pattern determiner 522 receives a block ACK 528 via the transceiver system 450, either indirectly (e.g., the transceiver system 450 being part of the AP 110 in FIG. 1 and receiving information from one of the STAs 120) or directly (e.g., the transceiver system 450 being part of one of the STAs 120 in FIG. 1 and generating the block ACK information itself). This type of channel information can be leveraged by the loss pattern determiner 522 to create a loss pattern comprising a plurality of values indicating reception success or reception failure of a corresponding MPDU at a receiving station (e.g., one of the STAs 120). Information from multiple block ACKs may be aggregated as required over a time window of interest (e.g., a short time window on the order of 80-100 ms), which may be a sliding window to allow for repeated (e.g., continuous or periodic) analysis of channel conditions.

In some designs, the loss pattern determiner 522 may perform certain pre-processing operations to clean up the block ACK bitmaps for creating the loss pattern. For example, the loss pattern determiner 522 may pre-process the one or more block ACK bitmaps to remove any ACK bits corresponding to MPDUs that were not actually re-transmitted (e.g., by the AP 110 in FIG. 1 to one of the STAs 120) but are still being acknowledged as part of the retransmission procedure (e.g., for sequencing control purposes). The deleted bits correspond to MPDUs that were successfully decoded in the first round of transmission, and hence, are already represented in a preceding block ACK. In this way, the loss pattern may be considered to represent the “true-bitmap,” without the redundancies that may be introduced by simply merging raw block ACK data.

The RL vector computation engine 524 is configured to compute a RL vector characterizing, in length and frequency of occurrence, runs of consecutive reception failures and/or reception successes in the loss pattern. For example, the loss pattern may comprise a series of ‘1’s indicating a reception success and ‘0’s indicating a reception failure of respective MPDUs, with a certain number of runs of consecutive ‘1’s (one-run-lengths) of length 1, 2, 3, 5, etc., as well as a certain number of runs of consecutive ‘0’s (zero-run-lengths) of length 1, 2, 3, 5, etc. The RL vector computation engine 524 may then count the number of zero-run-lengths of length 1, the number of zero-run-lengths of length 2, the number of zero-run-lengths of length 3, the number of zero-run-lengths of length 4, the number of zero-run-lengths of length 5, and so on. In addition or alternatively, the RL vector computation engine 524 may then count the number of one-run-lengths of length 1, the number of one-run-lengths of length 2, the number of one-run-lengths of length 3, the number of one-run-lengths of length 4, the number of one-run-lengths of length 5, and so on. The resultant RL vector may then be populated with these values, for the zero-run-lengths, the one-run-lengths, or both.

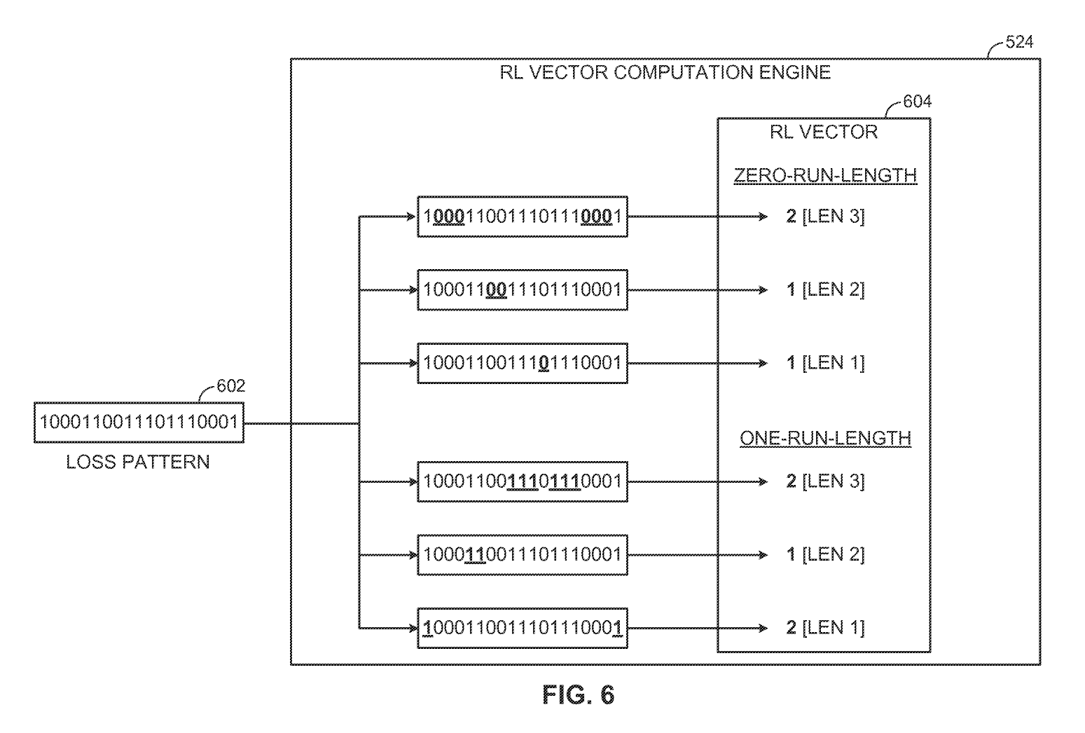

FIG. 6 is an example data flow diagram illustrating the population of an example RL vector. It will be appreciated that the example values shown here are simplified for illustration purposes, and may vary depending on the signaling environment, the time window of interest, and so on. In this example, a loss pattern 602 is generated (e.g., by the loss pattern determiner 522) as ‘1000110011101110001’ and fed to the RL vector computation engine 524. The RL vector computation engine 524 identifies 1 zero-run-length of length 1, 1 zero-run-length of length 2, and 2 zero-run-lengths of length 3. The RL vector computation engine 524 also identifies 2 one-run-lengths of length 1, 1 one-run-length of length 2, and 2 one-run-lengths of length 3. The RL vector computation engine 524 then populates a RL vector 604 as follows: 1 [LEN 1], 1 [LEN 2], and 2 [LEN 3] for the zero-run-lengths; and 2 [LEN 1], 1 [LEN 2], and 2 [LEN 3] for the one-run-lengths.

Returning to FIG. 5, the RL signature analyzer 526 is configured to compare the RL vector to a corresponding RL signature for distinguishing bursty from non-bursty interference. Different RL signatures may be employed for different statistical measures of the RL vector contents. For example, the RL signature may comprise a baseline RL distribution of consecutive reception failures that is characteristic of non-bursty interference. As another example, the RL signature may comprise a RL threshold of consecutive reception failures that represents a dividing line between bursty and non-bursty interference. In some designs, the different RL signatures may be predetermined, while in other designs the different RL signatures may be dynamically determined and/or dynamically updated by the RL signature analyzer 526 based on empirical measurements of current or historical signaling conditions.

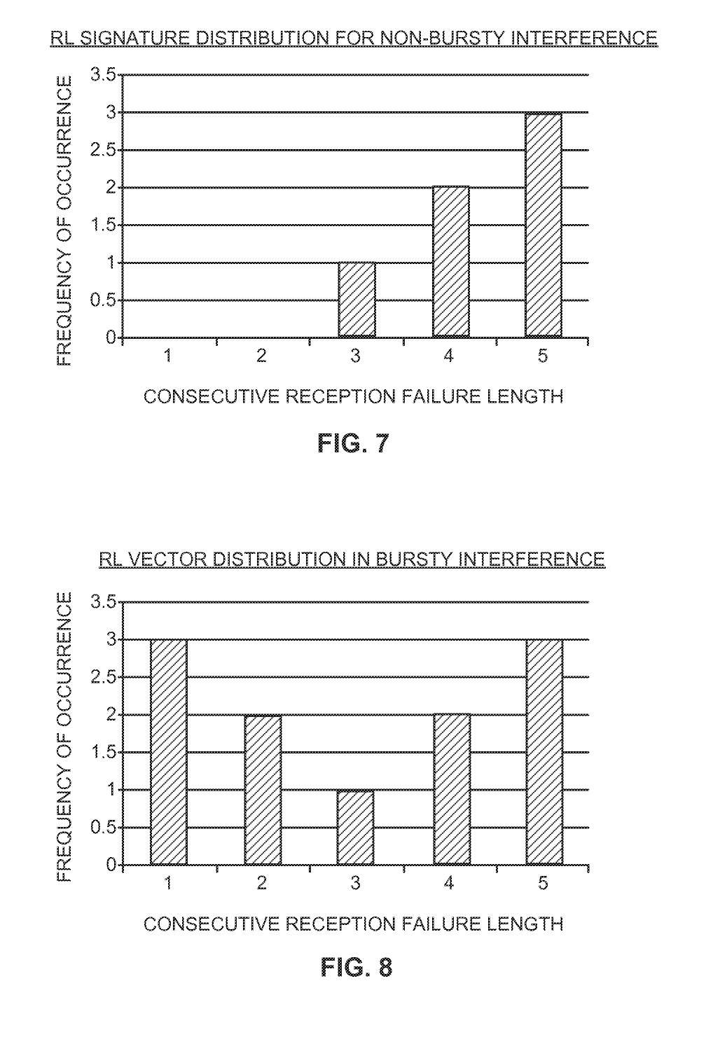

Several example RL signatures and generation/adaptation techniques are described below with reference to FIGS. 7-12.

FIG. 7 is an illustrative example of a RL distribution that may be employed as a RL signature. In this example, the RL signature comprises a baseline RL distribution of consecutive reception failures that is characteristic of non-bursty interference. It will be appreciated that the example values shown here are simplified for illustration purposes, and may vary depending on the signaling environment, the time window of interest, and so on.

In order to use such a baseline RL distribution for analyzing the RL vector, the RL signature analyzer 526 may compute a corresponding observed RL distribution of consecutive reception failures from the RL vector. The RL signature analyzer 526 may then compute a statistical distance between the observed RL distribution and the baseline RL distribution, and compare the statistical distance to a threshold indicative of bursty interference. Various statistical distance measures such as Kullback-Leibler divergence, total variation distance, Bhattacharya distance, etc., may be employed to gage the significance of such a statistical difference and determine whether it is sufficient to indicate bursty interference.

FIG. 8 is an illustrative example of a RL distribution that may be derived from the RL vector in bursty interference conditions. It will again be appreciated that the example values shown here are simplified for illustration purposes, and may vary depending on the signaling environment, the time window of interest, and so on. In general, however, it can be seen that the observed RL distribution in FIG. 8 under bursty interference conditions is shifted to the left (in terms of the consecutive reception failure length) as compared to the baseline RL distribution in FIG. 7 under non-bursty interference conditions. This may be attributed to the short-term (time-selective) nature of bursty interference where the interference is isolated to one (or potentially a small number) of MPDUs as discussed in more detail above. Such bursts of interference not only increase the number of short runs of consecutive reception failures observed, but also increase the total number of runs of consecutive reception failures observed. This also decreases the number of long runs of consecutive reception successes by breaking them up into shorter runs. Accordingly, such a characteristic distribution shift (e.g., via the emergence of a new, lower valued peak) may be used in various ways as, or to otherwise derive, a corresponding RL signature for distinguishing bursty from non-bursty interference.

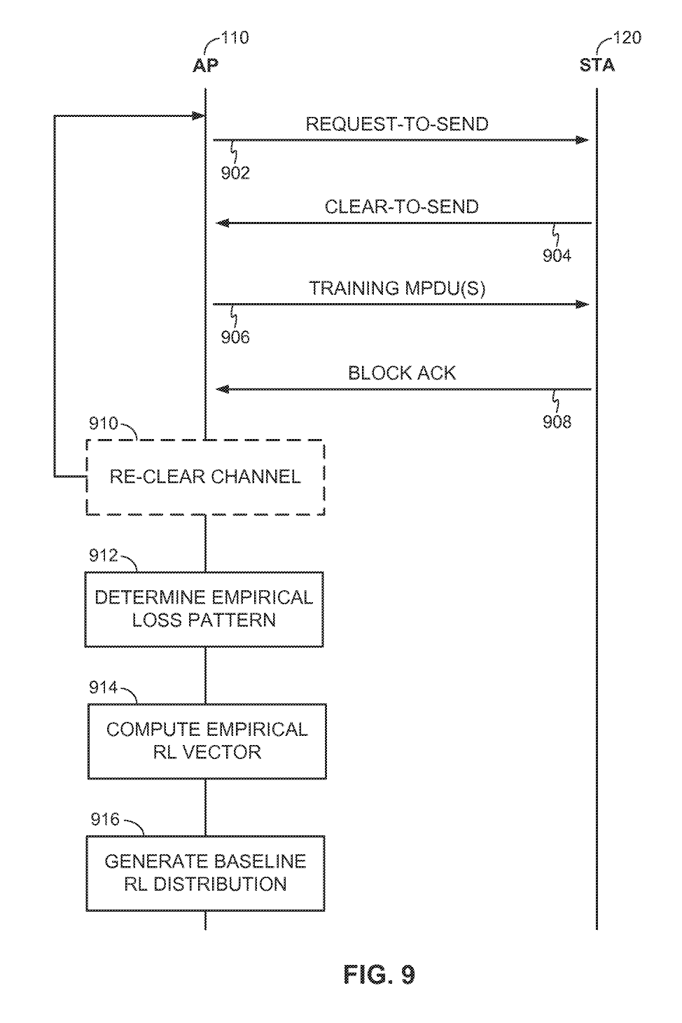

FIG. 9 is a signaling flow diagram illustrating the empirical generation of a baseline RL distribution that is characteristic of non-bursty interference. In this example, channel measurements are made by a Wi-Fi STA (e.g., one of the STAs 120 in FIG. 1) and provided to a Wi-Fi AP (e.g., the AP 110 in FIG. 1) under non-bursty channel conditions for learning phase characterization.

As shown, to ensure that any hidden nodes are not transmitting during the learning phase, the AP 110 initially sends a request-to-send (RTS) message 902 to the STA 120, and the STA 120 responds with a clear-to-send (CTS) message 904, thereby clearing the channel of potential bursty interference. The AP 110 then transmits one or more training MPDUs to the STA 120 following the RTS/CTS exchange. The STA 120 in turn sends a block ACK response 908 to the AP 110 indicating reception success or reception failure of each training MPDU.

As necessary, the AP 110 may re-clear the channel 910 to ensure that bursty interference is not introduced into the learning phase (e.g., after each block ACK 908). In addition, because reception success and failure rates generally vary based on the modulation-and-coding scheme (MCS) employed for transmission and the signal strength (e.g., received signal strength indicator (RSSI)) experienced on the channel, the training MPDUs 906 may be associated with a respective MCS and a respective RSSI, such that different baseline RL distributions may be generated for different MCS and RSSI pairs.

Based on the block ACK responses collected, the AP 110 determines an empirical loss pattern (block 912). The AP 110 may then compute an empirical RL vector characterizing, in length and frequency of occurrence, runs of consecutive reception failures in the empirical loss pattern (block 914), similar to the RL vector computation described above with reference to the RL vector computation engine 524. From the empirical RL vector, the AP 110 may generate a baseline RL distribution (block 916) that is characteristic of non-bursty interference, and which may therefore be used to distinguish between later observed bursty interference and otherwise expected reception failures due to non-bursty interference, such as channel fading and long data packet collisions.

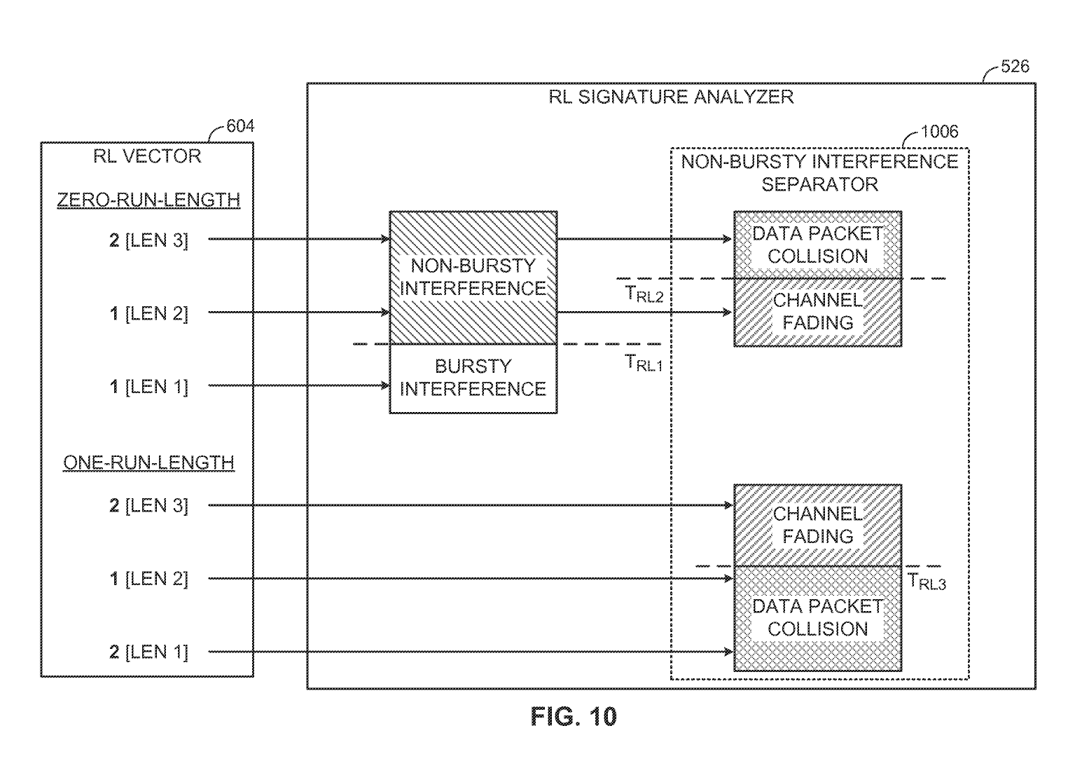

FIG. 10 is an illustrative example of a RL threshold that may be employed as a RL signature. In this example, the RL signature comprises a RL threshold (T_{RL1}) of consecutive reception failures that is characteristic of non-bursty interference. It will be appreciated that the example values shown here are simplified for illustration purposes, and may vary depending on the signaling environment, the time window of interest, and so on.

In order to use such a RL threshold for analyzing the RL vector (illustrated here as the example RL vector 604 described in more detail above with reference to FIG. 6), the RL signature analyzer 526 may perform hypothesis testing of each consecutive reception failure length in the RL vector 604 against the RL threshold T_{RL1} to separate consecutive reception failures corresponding to bursty interference from consecutive reception failures corresponding to non-bursty interference. As shown, any consecutive reception failure length in the RL vector 604 that falls below the RL threshold T_{RL1} (e.g., zero-run-lengths of length 1 in the illustrated example) may be determined to be due to bursty interference, while any consecutive reception failure length in the RL vector 604 that is above the RL threshold T_{RL1} (e.g., zero-run-lengths of length 2, 3, or higher in the illustrated example) may be determined to be due to non-bursty interference.

Although the specific cutoff value for the RL threshold T_{RL1} may vary and may even be dynamically adapted, in general, lower consecutive reception failure lengths may be associated with bursty interference while higher consecutive reception failure lengths may be associated with non-bursty interference. This again may be attributed to the short-term (time-selective) nature of bursty interference where the interference is isolated to one (or potentially a small number) of MPDUs as discussed in more detail above. Such bursts of interference not only increase the number of short runs of consecutive reception failures observed, but also decrease the number of long runs of consecutive reception successes by breaking them up into shorter runs. Accordingly, such a characteristic threshold pattern may be used in various ways as, or to otherwise derive, a corresponding RL threshold for distinguishing bursty from non-bursty interference.

In some designs, further processing may be performed by a non-bursty interference separator 1006 to further distinguish between different types of non-bursty interference (e.g., channel fading vs. data packet collisions). For example, as is further illustrated in FIG. 10, the RL signature analyzer 526 may perform hypothesis testing of each of the consecutive reception failures corresponding to non-bursty interference against a second RL threshold (T_{RL2}) to separate consecutive reception failures corresponding to channel fading interference from consecutive reception failures corresponding to data packet collision interference. As shown, any consecutive reception failure length in the RL vector 604 that is above the second RL threshold T_{RL2} (e.g., zero-run-lengths of length 3 or higher in the illustrated example) may be determined to be due to data packet collisions, while any consecutive reception failure length in the RL vector 604 that falls below the second RL threshold T_{RL2} but above the first RL threshold T_{RL1} (e.g., zero-run-lengths of length 2 in the illustrated example) may be determined to be due to channel fading.

In addition or as an alternative, the RL signature analyzer 526 may perform hypothesis testing of consecutive reception successes in the RL vector 604, between each of the consecutive reception failures corresponding to non-bursty interference, against a third RL threshold (T_{RL3}) to separate consecutive reception failures corresponding to channel fading interference from consecutive reception failures corresponding to data packet collision interference. In general, it has been observed that for data packet collisions, there are usually a few consecutive reception successes between runs of consecutive reception failures, while for channel fading, the consecutive reception successes are typically longer. Thus, as is further illustrated in FIG. 10, for the consecutive reception successes between the consecutive reception failures, consecutive reception success lengths in the RL vector 604 that fall below the third RL threshold T_{RL3} (e.g., one-run-lengths of length 1 or 2 in the illustrated example) may be used to identify data packet collision interference, while consecutive reception success lengths in the RL vector 604 that are above the third RL threshold T_{RL3} (e.g., one-run-lengths of length 3 or higher in the illustrated example) may be used to identify channel fading interference.

Because reception success and failure rates generally vary based on the MCS employed for transmission and the conditions experienced on the link by a particular subscriber station, the RL thresholds may be associated with a respective MCS and a respective subscriber station, such that different RL thresholds may be used for different MCS and subscriber station pairs.

As discussed above, the specific cutoff value for the RL thresholds may be dynamically adapted to current system conditions or other factors. For example, the RL threshold may be empirically adapted utilizing a pattern recognition algorithm (e.g., Bayesian pattern classification) to distinguish between bursty and non-bursty consecutive reception failure lengths. The pattern recognition may be performed in different ways, including on pre-classified loss pattern aggregations as well as unclassified loss pattern aggregations.

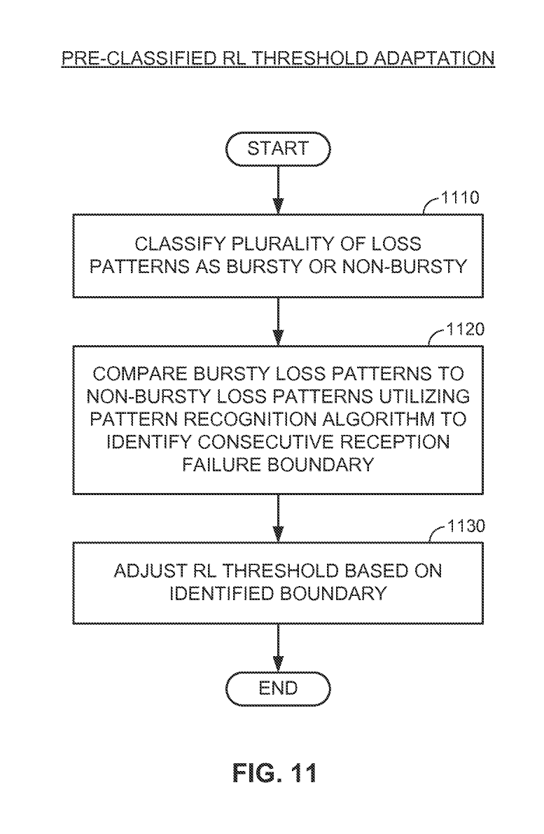

FIG. 11 is a processing flow diagram illustrating the empirical adaptation of a RL threshold for separating bursty and non-bursty interference. In this example, the loss pattern aggregations are pre-classified into distinct bursty and non-bursty aggregation classes based on whether bursty interference is detected or not.

As shown, each of a plurality of loss patterns collected over time may be initially classified as bursty or non-bursty (block 1110). This may be done based on a threshold number of consecutive reception failures in the loss pattern falling below the RL threshold discussed above. For example, if 80% of the consecutive reception failures in a given loss pattern have a length that falls below the RL threshold T_{RL1} (e.g., zero-run-lengths of length 1 in the example illustrated in FIG. 10) the loss pattern as a whole may be classified as bursty. Otherwise, the loss pattern may be classified as non-bursty. Once a sufficient number have been collected, loss patterns of the same class may be separately aggregated (e.g., into respective distributions) for enhanced statistical accuracy.

The loss patterns classified as bursty may then be compared to the loss patterns classified as non-bursty (block 1120). This may be done by utilizing the pattern recognition algorithm referenced above (e.g., Bayesian pattern classification) to identify a boundary between bursty and non-bursty consecutive reception failure lengths. Because reception success and failure rates generally vary based on the MCS employed for transmission and the conditions experienced on the link by a particular subscriber station, the loss pattern aggregations and classifications may be performed separately for a respective MCS and a respective subscriber station. In any case, the RL threshold may then be adjusted based on the identified boundary (block 1130).

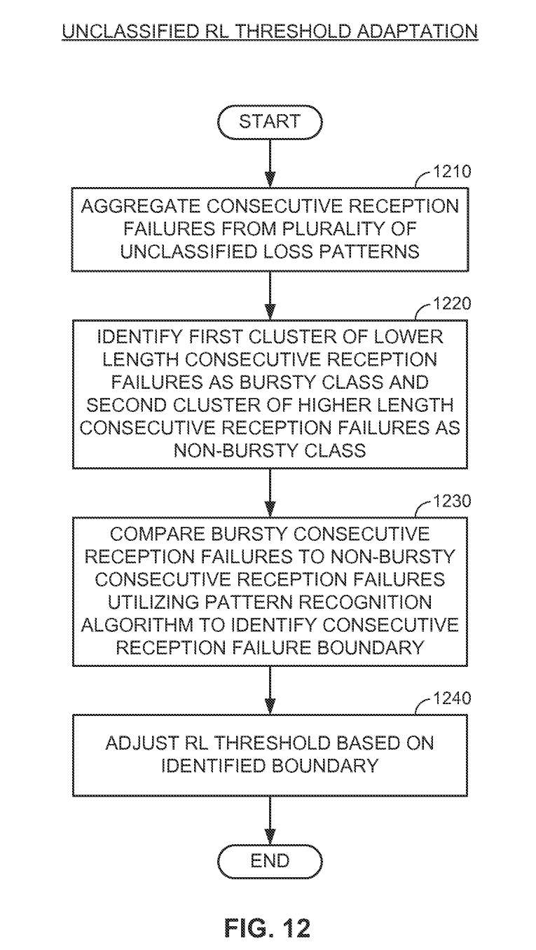

FIG. 12 is another processing flow diagram illustrating the empirical adaptation of a RL threshold for separating bursty and non-bursty interference. In this example, the bursty and non-bursty classes are not presumed to be known in advance.

As shown, consecutive reception failures may be aggregated from a plurality of unclassified loss patterns collected over time (block 1210). Because of the disparate effects of bursty and non-bursty interference described in more detail above, a distribution of the aggregated consecutive reception failures will tend to exhibit a bimodal pattern. Accordingly, a first cluster of lower length consecutive reception failures may be identified among the aggregated consecutive reception failures and a second cluster of higher length consecutive reception failures may be identified among the aggregated consecutive reception failures (block 1220). The first cluster generally corresponds to a bursty class of consecutive reception failures and the second cluster generally corresponds to a non-bursty class of consecutive reception failures.

The consecutive reception failures classified as bursty may then be compared to the consecutive reception failures classified as non-bursty (block 1230). This may again be done by utilizing the pattern recognition algorithm referenced above (e.g., Bayesian pattern classification) to identify a boundary between bursty and non-bursty consecutive reception failure lengths. Because reception success and failure rates generally vary based on the MCS employed for transmission and the conditions experienced on the link by a particular subscriber station, the loss pattern aggregations and classifications may be performed separately for a respective MCS and a respective subscriber station. In any case, the RL threshold may then be adjusted based on the identified boundary (block 1240).

Returning to FIG. 5, in response to the identification of a bursty interference condition on the communication channel by the bursty interference detector 420, the bursty interference controller 430 may generate a bursty interference indicator, which may take different forms in different designs and applications, ranging for example from a flag identifying the presence of bursty interference to more sophisticated control signaling.

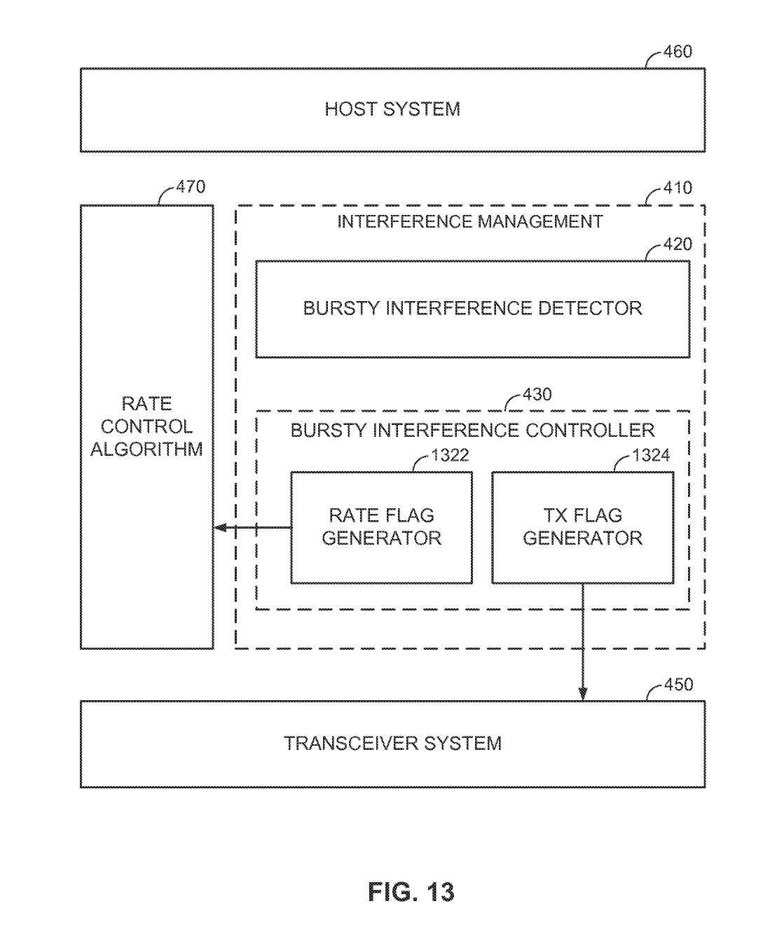

FIG. 13 is a block diagram illustrating an example design for one or more bursty interference control aspects of a bursty-interference-aware interference management module. In this example, the bursty interference controller 430 includes one or more bursty interference flag generators, two of which are shown for illustration purposes, including a rate flag generator 1322 and a transmit (TX) flag generator 1324.

The rate flag generator 1322 is configured to output a bursty interference indicator to the rate control algorithm 470. This type of indicator allows the rate control algorithm 470 to react to channel fading interference and packet collision interference without confusing them with bursty interference. For example, the rate control algorithm 470 may maintain the currently selected rate (e.g., for a predetermined duration) or in some cases increase the currently selected rate in response to a sudden increase in packet error rate (PER) when the increase is identified as corresponding to bursty interference. Maintaining the currently selected rate even when PER increases suddenly prevents the short interference burst from affecting a larger proportion of packets as would be the case at lower rates, and keeps throughput from dropping further.

The TX flag generator 1324 is configured to output a bursty interference indicator to the transceiver system 450. This type of indicator allows the transceiver system 450 to schedule transmissions around any perceived bursty interference. For example, the transceiver system 450 may identify a corresponding duty cycle of a jammer entity associated with the bursty interference, and schedule data transmissions at other times.

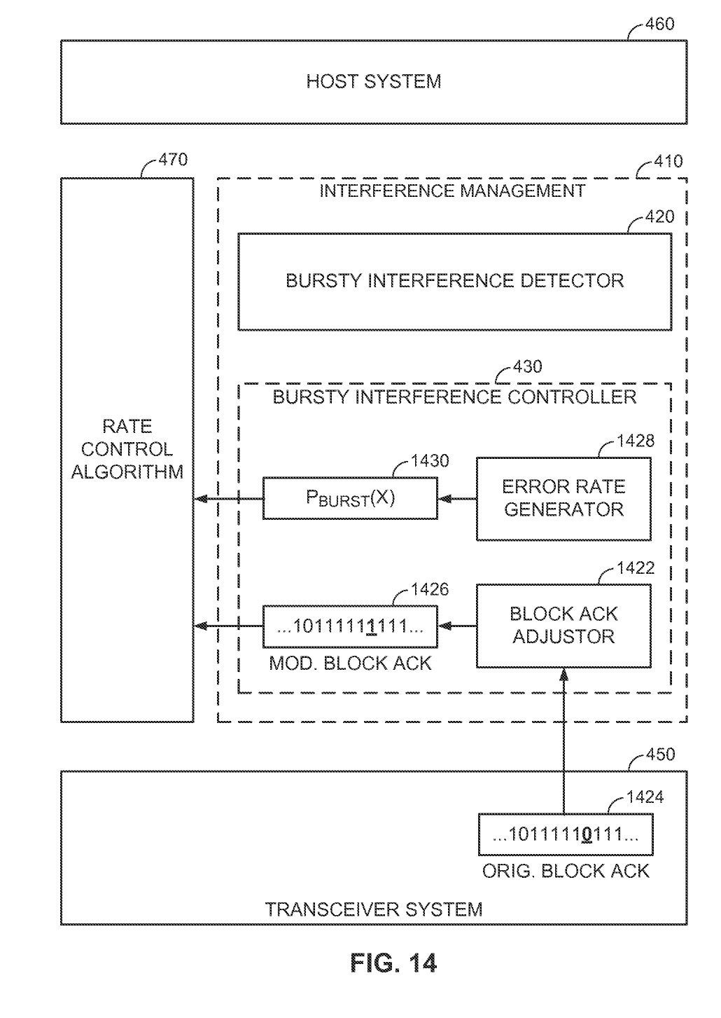

FIG. 14 is a block diagram illustrating another example design for one or more bursty interference control aspects of a bursty-interference-aware interference management module. In this example, the bursty interference controller 430 includes one or more rate control metric adjustors, two of which are shown for illustration purposes, including a block ACK adjustor 1422 and an error rate generator 1428.

The block ACK adjustor 1422 is configured to output a modified block ACK to the rate control algorithm 470. As discussed above, aggregation and acknowledgment via a block ACK may improve throughput and efficiency, but ordinary block ACKs do not distinguish between different types of interference. Accordingly, as with the rate flag indicator of FIG. 13, by modifying an original block ACK to, for example, exclude short burst errors, the rate control algorithm 470 may be controlled to react to channel fading interference and packet collision interference without confusing them with bursty interference. In the illustrated example, the block ACK adjustor 1422 receives an original block ACK 1424 (e.g., from the transceiver system 450), identifies any errors that may be due to short interference bursts (one such error is shown for illustration purposes), and scrubs those errors before passing a modified block ACK 1426 to the rate control algorithm 470.

The error rate generator 1428 is configured to collect bursty error rate statistics and output a bursty error rate probability metric P_{burst}(X) 1430 to the rate control algorithm 470. The bursty error rate probability metric P_{burst}(X) 1430 provides a measure of MPDU losses due to short bursts of interference, in a manner similar to the non-bursty error rate probability metrics upon which conventional throughput calculations of the rate control algorithm 470 are based. By providing a separate error rate term for bursty interference as distinct from non-bursty (e.g., channel fading and packet collision) interference, a modified throughput formula may be used to more accurately capture the distinct effects of the different categories of interference, which, as discussed above, affect rate selection in different ways.

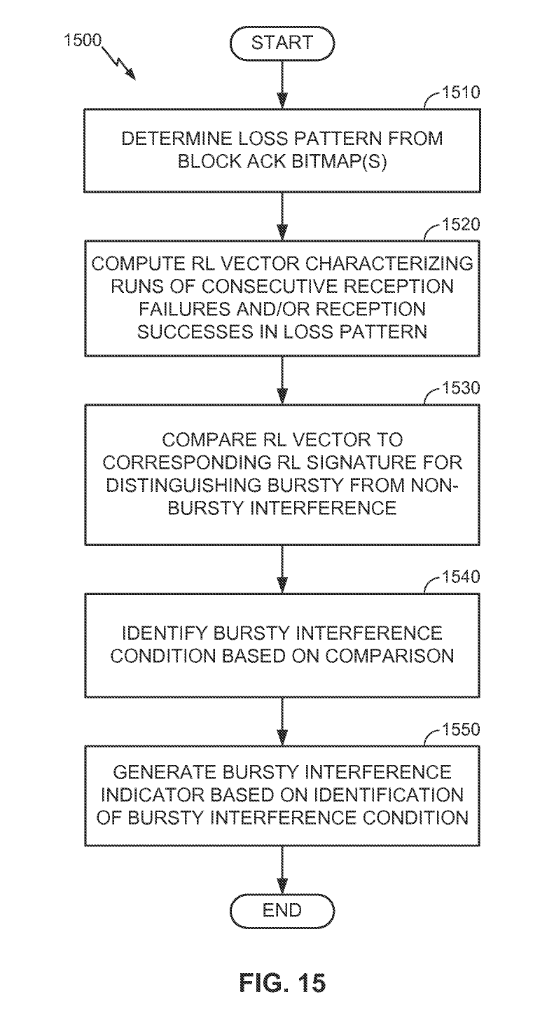

FIG. 15 is a flow diagram illustrating an example method of interference management for a wireless device in a wireless communication system. The method may be performed by a Wi-Fi access point, for example, such as the AP 110 in FIG. 1, or more generally any entity performing or assisting with rate control (e.g., one of the STAs 120 in FIG. 1). In this example, the method 1500 includes determining a loss pattern from one or more block ACK bitmaps (block 1510). The loss pattern may comprise a plurality of values indicating reception success or reception failure of a corresponding MPDU at a receiving station (e.g., one of the STAs 120 in FIG. 1). A RL vector may then be computed characterizing, in length and frequency of occurrence, runs of consecutive reception failures and/or reception successes in the loss pattern (block 1520), and the RL vector may be compared to a corresponding RL signature for distinguishing bursty from non-bursty interference (block 1530). Based on the comparison, a bursty interference condition may be identified (block 1540) and a bursty interference indicator may be generated (block 1550).

As discussed in more detail above, the determining of the loss pattern may be performed in different ways. For example, the determining may comprise aggregating information from multiple block ACK bitmaps among the one or more block ACK bitmaps over a time window of interest. The time window of interest may be a sliding time window and the aggregating may be performed repeatedly at successive locations of the sliding time window. Moreover, the aggregating may comprise pre-processing the one or more block ACK bitmaps to remove any redundant ACK bits corresponding to MPDUs that were not re-transmitted.

Different RL signatures may be employed for different statistical measures of the RL vector contents. For example, the RL signature may comprise a baseline RL distribution of consecutive reception failures that is characteristic of non-bursty interference. In this example, comparing the RL vector to the RL signature may be performed by computing an observed RL distribution of consecutive reception failures from the RL vector, computing a statistical distance between the observed RL distribution and the baseline RL distribution, and comparing the statistical distance to a threshold indicative of bursty interference.

In some designs, such a baseline RL distribution may be empirically generated. For example, empirically generating the baseline RL distribution may be performed by initially exchanging RTS and CTS signaling with one or more subscriber stations (e.g., one of the STAs 120 in FIG. 1) and transmitting one or more training MPDUs to the one or more subscriber stations following the RTS/CTS exchange. Block ACK responses from the one or more subscriber stations may then be collected, indicating reception success or reception failure of each training MPDU. An empirical loss pattern may be determined from the block ACK responses and an empirical RL vector may be computed characterizing, in length and frequency of occurrence, runs of consecutive reception failures in the empirical loss pattern. The baseline RL distribution may then be generated from the empirical RL vector. The training MPDUs may be associated with a respective MCS and a respective RSSI, such that different baseline RL distributions may be generated for different MCS and RSSI pairs.

As another example, the RL signature may comprise a RL threshold of consecutive reception failures that is characteristic of non-bursty interference. In this example, comparing the RL vector to the RL signature may be performed by hypothesis testing of each consecutive reception failure length in the RL vector against the RL threshold to separate consecutive reception failures corresponding to bursty interference from consecutive reception failures corresponding to non-bursty interference. When desired, the comparing may further comprise hypothesis testing of each of the consecutive reception failures corresponding to non-bursty interference against a second RL threshold to separate consecutive reception failures corresponding to channel fading interference from consecutive reception failures corresponding to data packet collision interference. In addition or as an alternative, the comparing may further comprise hypothesis testing of consecutive reception successes in the RL vector, between each of the consecutive reception failures corresponding to non-bursty interference, against a third RL threshold to separate consecutive reception failures corresponding to channel fading interference from consecutive reception failures corresponding to data packet collision interference.

In some designs, such a RL threshold may be empirically adapted utilizing a pattern recognition algorithm to distinguish between bursty and non-bursty consecutive reception failure lengths. For example, the adapting may be performed by initially classifying each of a plurality of loss patterns as bursty or non-bursty based on a threshold number of consecutive reception failures in the loss pattern falling below the RL threshold. Loss patterns classified as bursty may then be compared to loss patterns classified as non-bursty utilizing the pattern recognition algorithm to identify a boundary between bursty and non-bursty consecutive reception failure lengths. The RL threshold may accordingly be adapted based on the identified boundary. As another example, the adapting may be performed by initially aggregating consecutive reception failures from a plurality of unclassified loss patterns, and identifying a first cluster of lower length consecutive reception failures among the aggregated consecutive reception failures as a bursty class of consecutive reception failures and a second cluster of higher length consecutive reception failures among the aggregated consecutive reception failures as a non-bursty class of consecutive reception failures. Consecutive reception failures classified as bursty may then be compared to consecutive reception failures classified as non-bursty utilizing the pattern recognition algorithm to identify a boundary between bursty and non-bursty consecutive reception failure lengths. The RL threshold may then be adapted based on the identified boundary.

In some designs, the one or more block ACK bitmaps may be received by an access point (e.g., the AP 110 in FIG. 1) from a subscriber station (e.g., one of the STAs 120 in FIG. 1), with the access point performing the determining (block 1510), the computing (block 1520), and the comparing (block 1530). Alternatively, the one or more block ACK bitmaps may be generated by a subscriber station (e.g., one of the STAs 120 in FIG. 1), with the subscriber station performing the determining (block 1510), the computing (block 1520), and the comparing (block 1530).

As further discussed in more detail above, the generating (block 1550) may comprise generating a flag for a rate control algorithm operating at the wireless device. Alternatively or in addition, the generating (block 1550) may comprise modifying at least one bit of a block ACK bitmap based on the identification of the bursty interference condition.

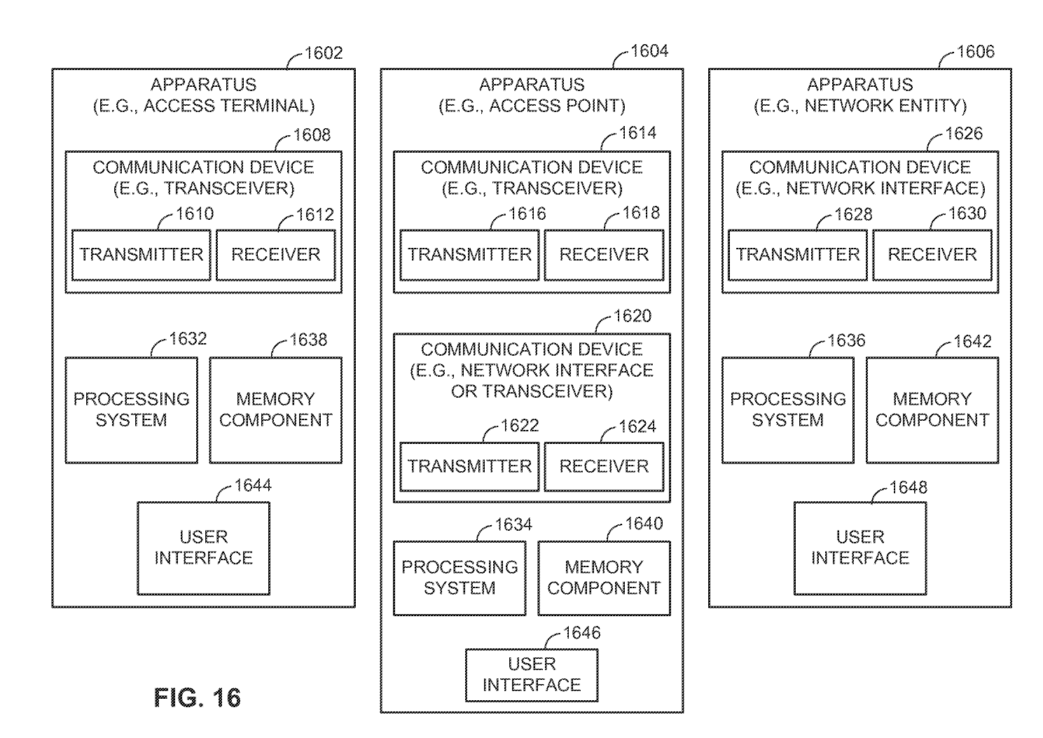

FIG. 16 illustrates several sample components (represented by corresponding blocks) that may be incorporated into an apparatus 1602, an apparatus 1604, and an apparatus 1606 (e.g., corresponding to an access terminal, an access point, and a network entity, respectively) to support interference management operations as taught herein. It should be appreciated that these components may be implemented in different types of apparatuses in different implementations (e.g., in an ASIC, in an SoC, etc.). The described components also may be incorporated into other apparatuses in a communication system. For example, other apparatuses in a system may include components similar to those described to provide similar functionality. Also, a given apparatus may contain one or more of the described components. For example, an apparatus may include multiple transceiver components that enable the apparatus to operate on multiple carriers and/or communicate via different technologies.

The apparatus 1602 and the apparatus 1604 each include at least one wireless communication device (represented by the communication devices 1608 and 1614 (and the communication device 1620 if the apparatus 1604 is a relay)) for communicating with other nodes via at least one designated radio access technology. Each communication device 1608 includes at least one transmitter (represented by the transmitter 1610) for transmitting and encoding signals (e.g., messages, indications, information, and so on) and at least one receiver (represented by the receiver 1612) for receiving and decoding signals (e.g., messages, indications, information, pilots, and so on). Similarly, each communication device 1614 includes at least one transmitter (represented by the transmitter 1616) for transmitting signals (e.g., messages, indications, information, pilots, and so on) and at least one receiver (represented by the receiver 1618) for receiving signals (e.g., messages, indications, information, and so on). If the apparatus 1604 is a relay access point, each communication device 1620 may include at least one transmitter (represented by the transmitter 1622) for transmitting signals (e.g., messages, indications, information, pilots, and so on) and at least one receiver (represented by the receiver 1624) for receiving signals (e.g., messages, indications, information, and so on).

A transmitter and a receiver may comprise an integrated device (e.g., embodied as a transmitter circuit and a receiver circuit of a single communication device) in some implementations, may comprise a separate transmitter device and a separate receiver device in some implementations, or may be embodied in other ways in other implementations. In some aspects, a wireless communication device (e.g., one of multiple wireless communication devices) of the apparatus 1604 comprises a network listen module.

The apparatus 1606 (and the apparatus 1604 if it is not a relay access point) includes at least one communication device (represented by the communication device 1626 and, optionally, 1620) for communicating with other nodes. For example, the communication device 1626 may comprise a network interface that is configured to communicate with one or more network entities via a wire-based or wireless backhaul. In some aspects, the communication device 1626 may be implemented as a transceiver configured to support wire-based or wireless signal communication. This communication may involve, for example, sending and receiving: messages, parameters, or other types of information. Accordingly, in the example of FIG. 16, the communication device 1626 is shown as comprising a transmitter 1628 and a receiver 1630. Similarly, if the apparatus 1604 is not a relay access point, the communication device 1620 may comprise a network interface that is configured to communicate with one or more network entities via a wire-based or wireless backhaul. As with the communication device 1626, the communication device 1620 is shown as comprising a transmitter 1622 and a receiver 1624.

The apparatuses 1602, 1604, and 1606 also include other components that may be used in conjunction with interference management operations as taught herein. The apparatus 1602 includes a processing system 1632 for providing functionality relating to, for example, communicating with an access point to support interference management as taught herein and for providing other processing functionality. The apparatus 1604 includes a processing system 1634 for providing functionality relating to, for example, interference management as taught herein and for providing other processing functionality. The apparatus 1606 includes a processing system 1636 for providing functionality relating to, for example, interference management as taught herein and for providing other processing functionality. The apparatuses 1602, 1604, and 1606 include memory devices 1638, 1640, and 1642 (e.g., each including a memory device), respectively, for maintaining information (e.g., information indicative of reserved resources, thresholds, parameters, and so on). In addition, the apparatuses 1602, 1604, and 1606 include user interface devices 1644, 1646, and 1648, respectively, for providing indications (e.g., audible and/or visual indications) to a user and/or for receiving user input (e.g., upon user actuation of a sensing device such a keypad, a touch screen, a microphone, and so on).

For convenience, the apparatus 1602 is shown in FIG. 16 as including components that may be used in the various examples described herein. In practice, the illustrated blocks may have different functionality in different aspects.

The components of FIG. 16 may be implemented in various ways. In some implementations, the components of FIG. 16 may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 1608, 1632, 1638, and 1644 may be implemented by processor and memory component(s) of the apparatus 1602 (e.g., by execution of appropriate code and/or by appropriate configuration of processor components). Similarly, some or all of the functionality represented by blocks 1614, 1620, 1634, 1640, and 1646 may be implemented by processor and memory component(s) of the apparatus 1604 (e.g., by execution of appropriate code and/or by appropriate configuration of processor components). Also, some or all of the functionality represented by blocks 1626, 1636, 1642, and 1648 may be implemented by processor and memory component(s) of the apparatus 1606 (e.g., by execution of appropriate code and/or by appropriate configuration of processor components).

The teachings herein may be employed in a wireless multiple-access communication system that simultaneously supports communication for multiple wireless access terminals. Here, each terminal may communicate with one or more access points via transmissions on the forward and reverse links. The forward link (or downlink) refers to the communication link from the access points to the terminals, and the reverse link (or uplink) refers to the communication link from the terminals to the access points. This communication link may be established via a single-in-single-out system, a multiple-in-multiple-out (MIMO) system, or some other type of system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min {N_{T}, N_{R}}. Each of the N_{S} independent channels corresponds to a dimension. The MIMO system may provide improved performance (e.g., higher throughput and/or greater reliability) if the additional dimensionalities created by the multiple transmit and receive antennas are utilized.

A MIMO system may support time division duplex (TDD) and frequency division duplex (FDD). In a TDD system, the forward and reverse link transmissions are on the same frequency region so that the reciprocity principle allows the estimation of the forward link channel from the reverse link channel. This enables the access point to extract transmit beam-forming gain on the forward link when multiple antennas are available at the access point.

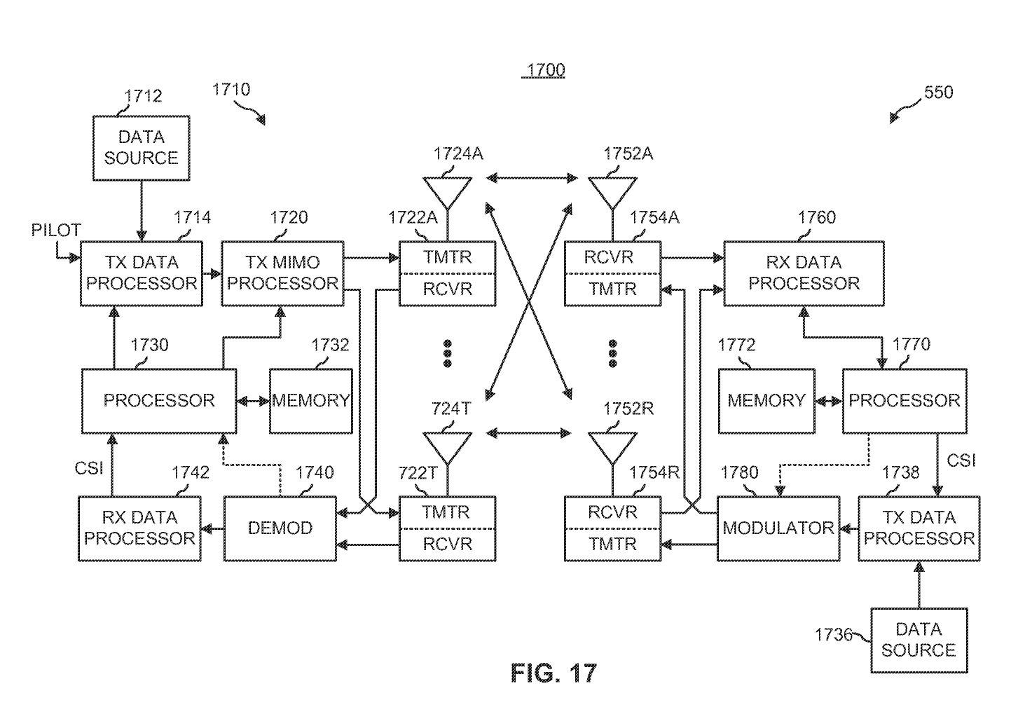

FIG. 17 illustrates in more detail the components of a wireless device 1710 (e.g., an AP) and a wireless device 1750 (e.g., an STA) of a sample communication system 1700 that may be adapted as described herein. At the device 1710, traffic data for a number of data streams is provided from a data source 1712 to a transmit (TX) data processor 1714. Each data stream may then be transmitted over a respective transmit antenna.

The TX data processor 1714 formats, codes, and interleaves the traffic data for each data stream based on a particular coding scheme selected for that data stream to provide coded data. The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by a processor 1730. A data memory 1732 may store program code, data, and other information used by the processor 1730 or other components of the device 1710.

The modulation symbols for all data streams are then provided to a TX MIMO processor 1720, which may further process the modulation symbols (e.g., for OFDM). The TX MIMO processor 1720 then provides NT modulation symbol streams to NT transceivers (XCVR) 1722A through 1722T. In some aspects, the TX MIMO processor 1720 applies beam-forming weights to the symbols of the data streams and to the antenna from which the symbol is being transmitted.

Each transceiver 1722 receives and processes a respective symbol stream to provide one or more analog signals, and further conditions (e.g., amplifies, filters, and upconverts) the analog signals to provide a modulated signal suitable for transmission over the MIMO channel. NT modulated signals from transceivers 1722A through 1722T are then transmitted from NT antennas 1724A through 1724T, respectively.

At the device 1750, the transmitted modulated signals are received by NR antennas 1752A through 1752R and the received signal from each antenna 1752 is provided to a respective transceiver (XCVR) 1754A through 1754R. Each transceiver 1754 conditions (e.g., filters, amplifies, and downconverts) a respective received signal, digitizes the conditioned signal to provide samples, and further processes the samples to provide a corresponding “received” symbol stream.

A receive (RX) data processor 1760 then receives and processes the NR received symbol streams from NR transceivers 1754 based on a particular receiver processing technique to provide NT “detected” symbol streams. The RX data processor 1760 then demodulates, deinterleaves, and decodes each detected symbol stream to recover the traffic data for the data stream. The processing by the RX data processor 1760 is complementary to that performed by the TX MIMO processor 1720 and the TX data processor 1714 at the device 1710.

A processor 1770 periodically determines which pre-coding matrix to use (discussed below). The processor 1770 formulates a reverse link message comprising a matrix index portion and a rank value portion. A data memory 1772 may store program code, data, and other information used by the processor 1770 or other components of the device 1750.

The reverse link message may comprise various types of information regarding the communication link and/or the received data stream. The reverse link message is then processed by a TX data processor 1738, which also receives traffic data for a number of data streams from a data source 1736, modulated by a modulator 1780, conditioned by the transceivers 1754A through 1754R, and transmitted back to the device 1710.

At the device 1710, the modulated signals from the device 1750 are received by the antennas 1724, conditioned by the transceivers 1722, demodulated by a demodulator (DEMOD) 1740, and processed by a RX data processor 1742 to extract the reverse link message transmitted by the device 1750. The processor 1730 then determines which pre-coding matrix to use for determining the beam-forming weights then processes the extracted message.

It will be appreciated that for each device 1710 and 1750 the functionality of two or more of the described components may be provided by a single component. It will be also be appreciated that the various communication components illustrated in FIG. 17 and described above may be further configured as appropriate to perform interference management as taught herein. For example, the processors 1730/1770 may cooperate with the memories 1732/1772 and/or other components of the respective devices 1710/1750 to perform the interference management as taught herein.

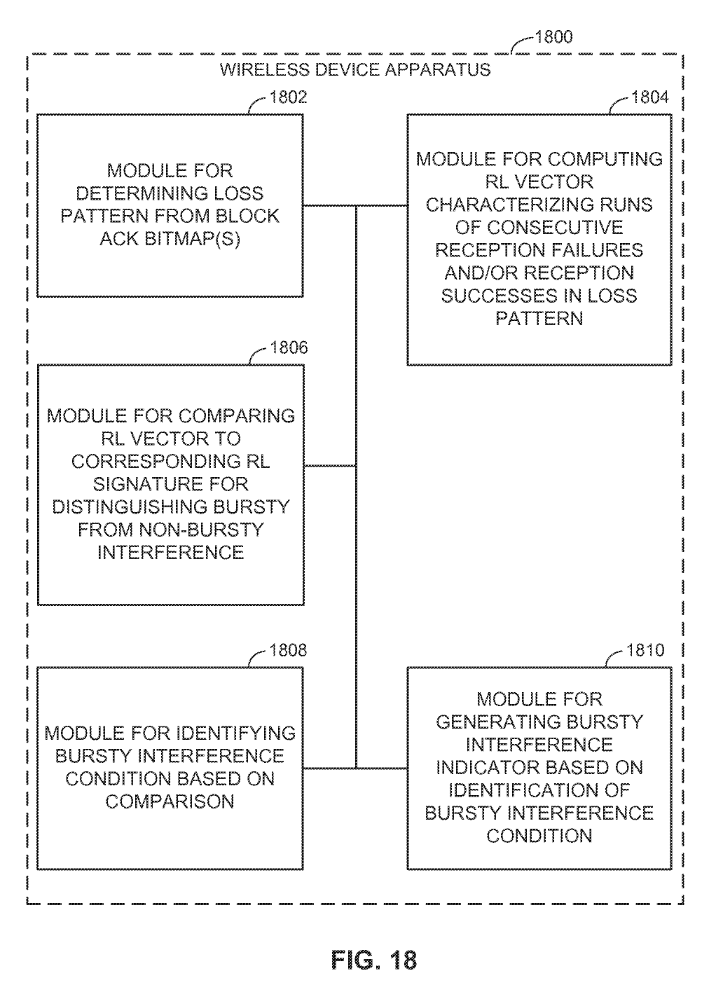

FIG. 18 illustrates an example (e.g., access point) wireless communication device apparatus 1800 represented as a series of interrelated functional modules. A module for determining 1802 may correspond at least in some aspects to, for example, a processing system as discussed herein. A module for computing 1804 may correspond at least in some aspects to, for example, a processing system as discussed herein. A module for comparing 1806 may correspond at least in some aspects to, for example, a processing system as discussed herein. A module for identifying 1808 may correspond at least in some aspects to, for example, a processing system as discussed herein. A module for generating 1810 may correspond at least in some aspects to, for example, a processing system as discussed herein.

The functionality of the modules of FIG. 18 may be implemented in various ways consistent with the teachings herein. In some aspects, the functionality of these modules may be implemented as one or more electrical components. In some aspects, the functionality of these blocks may be implemented as a processing system including one or more processor components. In some aspects, the functionality of these modules may be implemented using, for example, at least a portion of one or more integrated circuits (e.g., an ASIC). As discussed herein, an integrated circuit may include a processor, software, other related components, or some combination thereof. Thus, the functionality of different modules may be implemented, for example, as different subsets of an integrated circuit, as different subsets of a set of software modules, or a combination thereof. Also, it should be appreciated that a given subset (e.g., of an integrated circuit and/or of a set of software modules) may provide at least a portion of the functionality for more than one module.

In addition, the components and functions represented by FIG. 18 as well as other components and functions described herein, may be implemented using any suitable means. Such means also may be implemented, at least in part, using corresponding structure as taught herein. For example, the components described above in conjunction with the “module for” components of FIG. 18 also may correspond to similarly designated “means for” functionality. Thus, in some aspects one or more of such means may be implemented using one or more of processor components, integrated circuits, or other suitable structure as taught herein.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the disclosure can include a computer readable medium embodying a method for interference management for a wireless device in a wireless communication system. Accordingly, the disclosure is not limited to the illustrated examples.

While the foregoing disclosure shows illustrative aspects, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of interference management for a wireless device in a wireless communication system, comprising:
determining a loss pattern from one or more block acknowledgement (ACK) bitmaps, the loss pattern comprising a plurality of values indicating reception success or reception failure of a corresponding media access control (MAC) protocol data unit (MPDU) at a receiving station;
computing a run-length (RL) vector characterizing, in length and frequency of occurrence, runs of consecutive reception failures and/or reception successes in the loss pattern;
comparing the RL vector to a corresponding RL signature for distinguishing bursty from non-bursty interference;
identifying a bursty interference condition based on the comparison; and
generating a bursty interference indicator based on the identification of the bursty interference condition.

2. The method of claim 1, wherein the determining comprises aggregating information from multiple block ACK bitmaps among the one or more block ACK bitmaps over a time window of interest.

3. The method of claim 2, wherein the time window of interest is a sliding time window and the aggregating is performed repeatedly at successive locations of the sliding time window.

4. The method of claim 2, wherein the aggregating comprises pre-processing the one or more block ACK bitmaps to remove any redundant ACK bits corresponding to MPDUs that were not re-transmitted.

5. The method of claim 1, wherein the RL signature comprises a baseline RL distribution of consecutive reception failures that is characteristic of non-bursty interference.

6. The method of claim 5, wherein the comparing comprises:
computing an observed RL distribution of consecutive reception failures from the RL vector;
computing a statistical distance between the observed RL distribution and the baseline RL distribution; and
comparing the statistical distance to a threshold indicative of bursty interference.

7. The method of claim 5, further comprising empirically generating the baseline RL distribution, wherein the generating comprises:
exchanging request-to-send (RTS) and clear-to-send (CTS) signaling with one or more subscriber stations;
transmitting one or more training MPDUs to the one or more subscriber stations following the RTS/CTS exchange;
collecting block ACK responses from the one or more subscriber stations indicating reception success or reception failure of each training MPDU;
determining an empirical loss pattern from the block ACK responses;
computing an empirical RL vector characterizing, in length and frequency of occurrence, runs of consecutive reception failures in the empirical loss pattern; and
generating the baseline RL distribution from the empirical RL vector.

8. The method of claim 7, wherein the training MPDUs are associated with a respective modulation-and-coding scheme (MCS) and a respective received signal strength indicator (RSSI), and wherein different baseline RL distributions are generated for different MCS and RSSI pairs.

9. The method of claim 1, wherein the RL signature comprises a RL threshold of consecutive reception failures that is characteristic of non-bursty interference.

10. The method of claim 9, wherein the comparing comprises hypothesis testing of each consecutive reception failure length in the RL vector against the RL threshold to separate consecutive reception failures corresponding to bursty interference from consecutive reception failures corresponding to non-bursty interference.

11. The method of claim 10, wherein the comparing further comprises:
hypothesis testing of each of the consecutive reception failures corresponding to non-bursty interference against a second RL threshold to separate consecutive reception failures corresponding to channel fading interference from consecutive reception failures corresponding to data packet collision interference; and/or
hypothesis testing of consecutive reception successes in the RL vector, between each of the consecutive reception failures corresponding to non-bursty interference, against a third RL threshold to separate consecutive reception failures corresponding to channel fading interference from consecutive reception failures corresponding to data packet collision interference.

12. The method of claim 9, further comprising empirically adapting the RL threshold utilizing a pattern recognition algorithm to distinguish between bursty and non-bursty consecutive reception failure lengths.

13. The method of claim 12, wherein the adapting comprises:
classifying each of a plurality of loss patterns as bursty or non-bursty based on a threshold number of consecutive reception failures in the loss pattern falling below the RL threshold;
comparing loss patterns classified as bursty to loss patterns classified as non-bursty utilizing the pattern recognition algorithm to identify a boundary between bursty and non-bursty consecutive reception failure lengths; and
adjusting the RL threshold based on the identified boundary.

14. The method of claim 12, wherein the adapting comprises:
aggregating consecutive reception failures from a plurality of unclassified loss patterns;
identifying a first cluster of lower length consecutive reception failures among the aggregated consecutive reception failures as a bursty class of consecutive reception failures and a second cluster of higher length consecutive reception failures among the aggregated consecutive reception failures as a non-bursty class of consecutive reception failures;
comparing consecutive reception failures classified as bursty to consecutive reception failures classified as non-bursty utilizing the pattern recognition algorithm to identify a boundary between bursty and non-bursty consecutive reception failure lengths;
adjusting the RL threshold based on the identified boundary.

15. The method of claim 1, wherein the one or more block ACK bitmaps are received by an access point from a subscriber station, the access point performing the determining, computing, and comparing.

16. The method of claim 1, wherein the one or more block ACK bitmaps are generated by a subscriber station, the subscriber station performing the determining, computing, and comparing.

17. The method of claim 1, wherein the generating comprises generating a flag for a rate control algorithm operating at the wireless device.

18. The method of claim 1, wherein the generating comprises modifying at least one bit of a block ACK bitmap based on the identification of the bursty interference condition.

19. An apparatus for interference management for a wireless device in a wireless communication system, comprising:
a processor configured to:
determine a loss pattern from one or more block acknowledgement (ACK) bitmaps, the loss pattern comprising a plurality of values indicating reception success or reception failure of a corresponding media access control (MAC) protocol data unit (MPDU) at a receiving station,
compute a run-length (RL) vector characterizing, in length and frequency of occurrence, runs of consecutive reception failures and/or reception successes in the loss pattern,
compare the RL vector to a corresponding RL signature for distinguishing bursty from non-bursty interference,
identify a bursty interference condition based on the comparison, and
generate a bursty interference indicator based on the identification of the bursty interference condition; and
memory coupled to the processor for storing related data and instructions.

20. The apparatus of claim 19, wherein the determining comprises aggregating information from multiple block ACK bitmaps among the one or more block ACK bitmaps over a time window of interest.

21. The apparatus of claim 20, wherein the time window of interest is a sliding time window and the aggregating is performed repeatedly at successive locations of the sliding time window.

22. The apparatus of claim 20, wherein the aggregating comprises pre-processing the one or more block ACK bitmaps to remove any redundant ACK bits corresponding to MPDUs that were not re-transmitted.

23. The apparatus of claim 19, wherein the RL signature comprises a baseline RL distribution of consecutive reception failures that is characteristic of non-bursty interference.

24. The apparatus of claim 23, wherein the comparing comprises:
computing an observed RL distribution of consecutive reception failures from the RL vector;
computing a statistical distance between the observed RL distribution and the baseline RL distribution; and
comparing the statistical distance to a threshold indicative of bursty interference.

25. The apparatus of claim 23, wherein the processor is further configured to empirically generate the baseline RL distribution, wherein the generating comprises:
exchanging request-to-send (RTS) and clear-to-send (CTS) signaling with one or more subscriber stations;
transmitting one or more training MPDUs to the one or more subscriber stations following the RTS/CTS exchange;
collecting block ACK responses from the one or more subscriber stations indicating reception success or reception failure of each training MPDU;
determining an empirical loss pattern from the block ACK responses;
computing an empirical RL vector characterizing, in length and frequency of occurrence, runs of consecutive reception failures in the empirical loss pattern; and
generating the baseline RL distribution from the empirical RL vector.

26. The apparatus of claim 25, wherein the training MPDUs are associated with a respective modulation-and-coding scheme (MCS) and a respective received signal strength indicator (RSSI), and wherein different baseline RL distributions are generated for different MCS and RSSI pairs.

27. The apparatus of claim 19, wherein the RL signature comprises a RL threshold of consecutive reception failures that is characteristic of non-bursty interference.

28. The apparatus of claim 27, wherein the comparing comprises hypothesis testing of each consecutive reception failure length in the RL vector against the RL threshold to separate consecutive reception failures corresponding to bursty interference from consecutive reception failures corresponding to non-bursty interference.

29. The apparatus of claim 28, wherein the comparing further comprises:
hypothesis testing of each of the consecutive reception failures corresponding to non-bursty interference against a second RL threshold to separate consecutive reception failures corresponding to channel fading interference from consecutive reception failures corresponding to data packet collision interference; and/or
hypothesis testing of consecutive reception successes in the RL vector, between each of the consecutive reception failures corresponding to non-bursty interference, against a third RL threshold to separate consecutive reception failures corresponding to channel fading interference from consecutive reception failures corresponding to data packet collision interference.

30. The apparatus of claim 27, wherein the processor is further configured to empirically adapt the RL threshold utilizing a pattern recognition algorithm to distinguish between bursty and non-bursty consecutive reception failure lengths.

31. The apparatus of claim 30, wherein the adapting comprises:
classifying each of a plurality of loss patterns as bursty or non-bursty based on a threshold number of consecutive reception failures in the loss pattern falling below the RL threshold;
comparing loss patterns classified as bursty to loss patterns classified as non-bursty utilizing the pattern recognition algorithm to identify a boundary between bursty and non-bursty consecutive reception failure lengths; and
adjusting the RL threshold based on the identified boundary.

32. The apparatus of claim 30, wherein the adapting comprises:
aggregating consecutive reception failures from a plurality of unclassified loss patterns;
identifying a first cluster of lower length consecutive reception failures among the aggregated consecutive reception failures as a bursty class of consecutive reception failures and a second cluster of higher length consecutive reception failures among the aggregated consecutive reception failures as a non-bursty class of consecutive reception failures;
comparing consecutive reception failures classified as bursty to consecutive reception failures classified as non-bursty utilizing the pattern recognition algorithm to identify a boundary between bursty and non-bursty consecutive reception failure lengths;
adjusting the RL threshold based on the identified boundary.

33. The apparatus of claim 19, wherein the wireless device corresponds to an access point, the apparatus further comprising a receiver configured to receive the one or more block ACK bitmaps at the access point from a subscriber station.

34. The apparatus of claim 19, wherein the wireless device corresponds to a subscriber station, the processor being further configured to generate the one or more block ACK bitmaps at the subscriber station.

35. The apparatus of claim 19, wherein the generating comprises generating a flag for a rate control algorithm operating at the wireless device.

36. The apparatus of claim 19, wherein the generating comprises modifying at least one bit of a block ACK bitmap based on the identification of the bursty interference condition.

37. An apparatus for interference management for a wireless device in a wireless communication system, comprising:
means for determining a loss pattern from one or more block acknowledgement (ACK) bitmaps, the loss pattern comprising a plurality of values indicating reception success or reception failure of a corresponding media access control (MAC) protocol data unit (MPDU) at a receiving station;
means for computing a run-length (RL) vector characterizing, in length and frequency of occurrence, runs of consecutive reception failures and/or reception successes in the loss pattern;
means for comparing the RL vector to a corresponding RL signature for distinguishing bursty from non-bursty interference;
means for identifying a bursty interference condition based on the comparison; and
means for generating a bursty interference indicator based on the identification of the bursty interference condition.

38. The apparatus of claim 37, wherein the means for determining comprises means for aggregating information from multiple block ACK bitmaps among the one or more block ACK bitmaps over a time window of interest, wherein the aggregating comprises pre-processing the one or more block ACK bitmaps to remove any redundant ACK bits corresponding to MPDUs that were not re-transmitted.

39. The apparatus of claim 37, wherein the RL signature comprises a baseline RL distribution of consecutive reception failures that is characteristic of non-bursty interference.

40. The apparatus of claim 37, wherein the RL signature comprises a RL threshold of consecutive reception failures that is characteristic of non-bursty interference.

41. A non-transitory computer-readable medium comprising code, which, when executed by a processor, causes the processor to perform operations for interference management for a wireless device in a wireless communication system, the non-transitory computer-readable medium comprising:
code for determining a loss pattern from one or more block acknowledgement (ACK) bitmaps, the loss pattern comprising a plurality of values indicating reception success or reception failure of a corresponding media access control (MAC) protocol data unit (MPDU) at a receiving station;
code for computing a run-length (RL) vector characterizing, in length and frequency of occurrence, runs of consecutive reception failures and/or reception successes in the loss pattern;
code for comparing the RL vector to a corresponding RL signature for distinguishing bursty from non-bursty interference;
code for identifying a bursty interference condition based on the comparison; and
code for generating a bursty interference indicator based on the identification of the bursty interference condition.

42. The non-transitory computer-readable medium of claim 41, wherein the code for determining comprises code for aggregating information from multiple block ACK bitmaps among the one or more block ACK bitmaps over a time window of interest, wherein the aggregating comprises pre-processing the one or more block ACK bitmaps to remove any redundant ACK bits corresponding to MPDUs that were not re-transmitted.

43. The non-transitory computer-readable medium of claim 41, wherein the RL signature comprises a baseline RL distribution of consecutive reception failures that is characteristic of non-bursty interference.

44. The non-transitory computer-readable medium of claim 41, wherein the RL signature comprises a RL threshold of consecutive reception failures that is characteristic of non-bursty interference.
